(19) United States
(12) Patent Application Publication
(10) Pub. No.: US 2008/0073896 A1
(43) Pub. Date: Mar. 27, 2008

(54) Method of attaching pages to a credit card sized cover

(76) Inventors: Charles Russ Colby, Marina Del Rey, CA (US); Kenneth A. Tarlow, Corte Madera, CA (US)

Correspondence Address: Charles "Russ" Colby, 14003 Palawan Way # 111, Marina Del Rey, CA, 90292, US

(21) Appl. No.: 11/523,909

(22) Filed: Sep. 21, 2006

(51) Int. Cl. B42D 1/00

(52) U.S. Cl. 281/15.1

(57) ABSTRACT

A method of attaching book pages to a credit card sized cover by use of rectangular molded plastic assembly that includes, a folded molded plastic sheet and a page binder. The sheet has recessed portions that allow the thickness of a standard plastic credit card to be entrapped within the folded plastic assembly a pair of retaining blades are positioned within the folded assembly at an angle so that the blade portion is facing away from the plastic credit card. As the card is pushed into the folded plastic sheet it is prevented from being pulled out because of the blades. Each half of the folded sheet has a plurality apertures located adjacent and parallel to the living hinge. The apertures receive a spiral wire binding to retain a plurality of printed pages so that the pages form a book and the credit card sized sheet forms a book cover.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of printed advertising or informational devices and more specifically to a method of attaching a plurality of advertising or instructional pages to a credit card sized cover.

Credit cards and credit card sized transaction cards are well known. Some cards are used as gift cards where the card indicates a sum of money that can be spent with the card in a particular store. Another credit sized card is used in the hotel industry as a key for opening an electronic lock of a hotel room. Also well known are various advertising techniques that are found in magazines, newspapers and direct mail pieces that give the bearer a discount on merchandise or other services when the user presents the advertisement coupon to the corresponding retailer or service provider.

Most credit type cards have an identical shape and identical placement of a magnetic strip on the back for swiping in a transaction machine. It would seem beneficial to combine pages that advertise particular products, services or instructional information with the card, so that a user can benefit from a discounts, other offers or instructions when using the card that has an attached pages.

However, this has not been previously possible because the attachment of such pages would normally interfere with the use of the card when swiping it in a standard transaction machine or hotel room electronic lock. Additionally, It has not been possible to attach a number of coupons to a credit sized card without the use of an adhesive or by putting attachment holes in the card. These techniques are not suitable for on site attachment situations. For example, if a hotel clerk created a card type hotel key for a customer, it would be time consuming and difficult for the clerk to create an attachment means at the time of issuance of the card.

### BRIEF SUMMARY OF THE INVENTION

The primary object of the invention is to provide a method of attaching a plurality of printed pages to a credit card sized cover.

Another object of the invention is to proved a page to cover attachment means that allows a user to permanently attach a credit sized cover to a plurality of pages without needing special adhesives or punched holes in the credit card sized cover.

Another object of the invention is to provide a page to cover attachment means where the cover is a credit sized gift card, or credit card sized hotel key card, or standard credit card and where the card can be used in the standard way without the book portion interfering with the swiping of the magnetic stripe located on the back of the card.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method of attaching a plurality of pages to a credit card sized cover comprising: a rectangular molded plastic sheet, a pair of plastic card retaining blades, said plastic sheet being made of rigid material such as polypropylene and having a living hinge bisecting said sheet, said sheet including recessed portions to allow the thickness of a standard plastic credit card to be entrapped within said molded plastic sheet when said sheet is folded in half at said living hinge portion, each said folded sheet half including a retaining means for said retaining blades, said folded sheet half being forced to stay in a folded position by means of a plurality downwardly facing posts located the inside of the first said folded sheet and a plurality of matching post retaining sockets on the second said folded sheet, said retaining blades positioned at an angle so that said blade portion is facing away from said plastic credit card as said card is pushed into said folded plastic sheet so that said card is prevented from being pulled out of said folded plastic sheet by the digging in action of said retaining blades, each said folded sheet having a plurality of evenly spaced apertures located adjacent to and parallel to said living hinge so that when said sheet halves are folded, said apertures of each said folded sheet are aligned and said plurality of spaced apertures capable of receiving a standard spiral wire binding capable of retaining a plurality of printed pages so that said pages form a book and said credit card sized sheet forms a book cover.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the credit card to pages attachment means with the pages in the closed position.

FIG. 2 is a perspective view of the credit card to pages attachment means with the pages in the open position.

FIG. 3 is a plan view of the attachment means in the open position and ready to attach to a credit card.

FIG. 4 is a side section view of the attachment means and attached card and pages.

FIG. 5 is a perspective view of an alternate embodiment of the invention that includes an accordion fold page rather than standard pages.

FIG. 6 is a section view of an alternate embodiment of the invention that includes the use of a punched hole in the credit card that produces a thin version of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

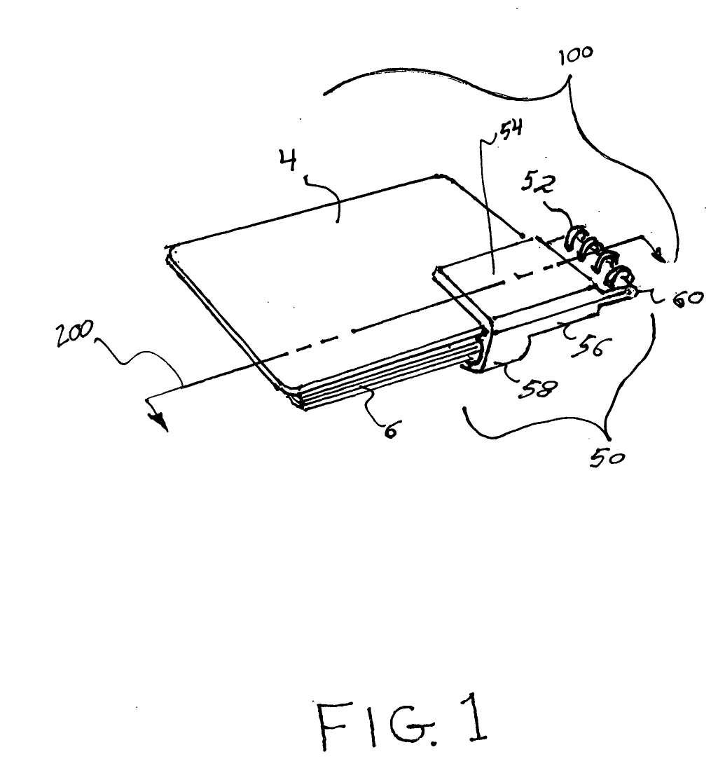

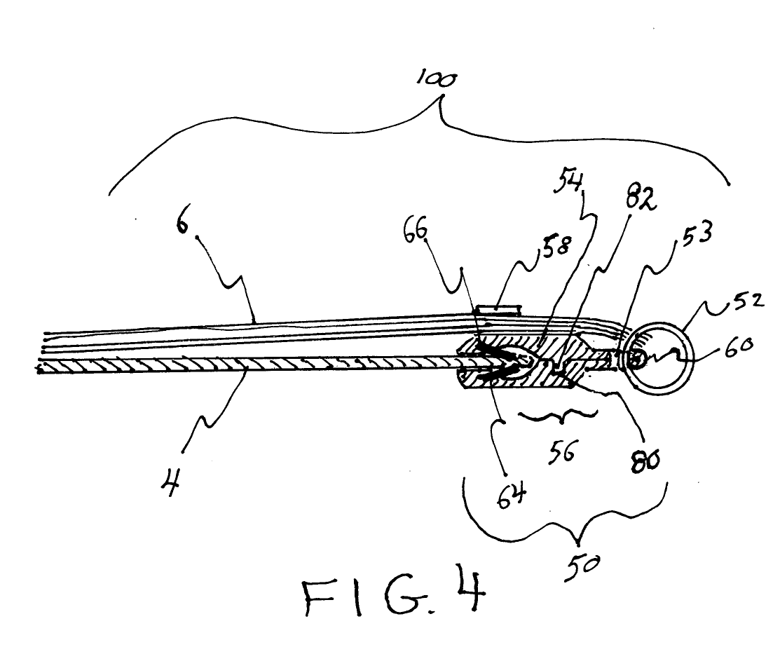

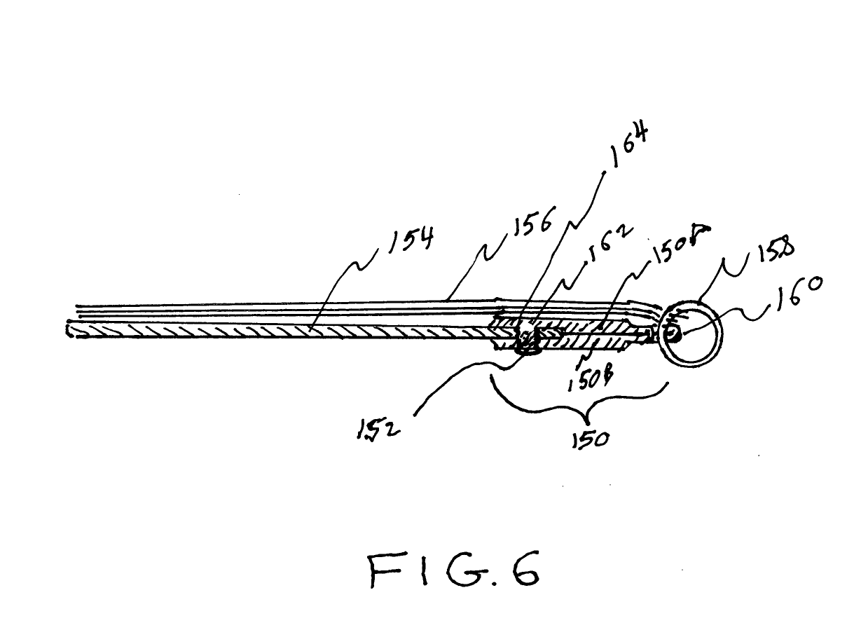

Referring now to FIG. 1 we see a perspective view of the invention 100 where a cover 4 to pages 6 mating assembly 50 can be seen. The book cover 4 is a plastic credit card sized card that can be used for purchasing transactions. There are several credit card sized transaction devices in use today. They include retail store gift cards, service related cards such as a road side assistance card or an insurance card, hotel key cards and standard credit and debit cards. The purpose of the present invention is to provide a connection means to add a plurality of advertising pages 6 to a card 4 so that when a person receives the card 4, he or she also receives coupon, or instructional pages 6 that relate to the services that the card 4 provides. For example, if a person was given a Sharper Image gift card, there may be a plurality of coupon pages attached to the card that would give the owner of the card discounts on specific Sharper Image merchandise. Section line 200 indicates the section view that can be seen in FIG. 4 and also the alternate embodiment shown in FIG. 6.

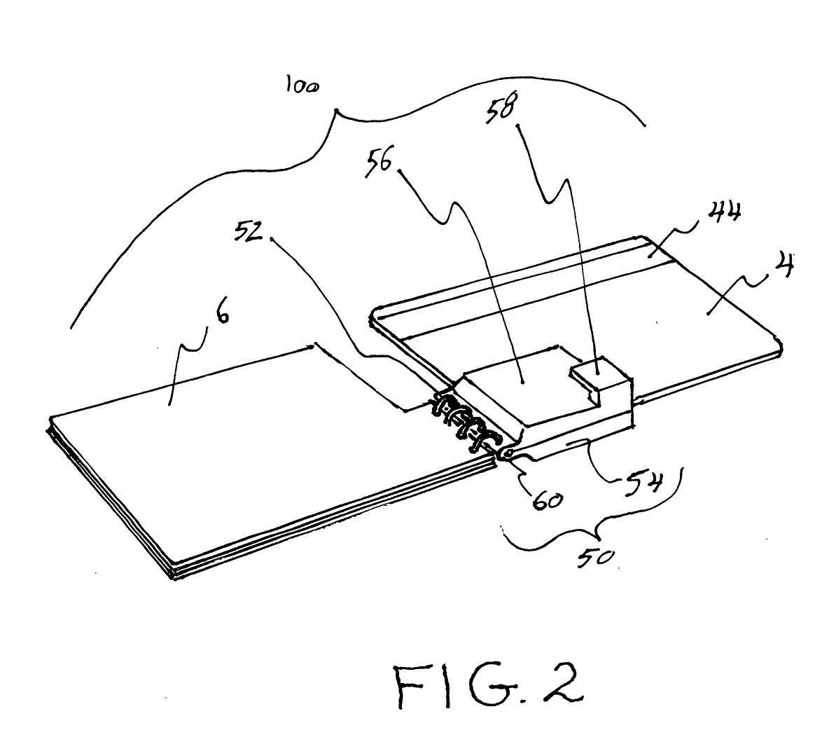

FIG. 2 shows a perspective view of the invention 100 with the card cover portion 4 in the open position. Coupon pages 6 can be seen attached to the mating assembly 50 by spiral binder 52. Tab 58 is designed to hold the pages 6 in close proximity to cover 4 when not being used. The magnetic strip 44 is able to be used in normal swiping transaction machines because the mating assembly 50 is sufficiently out of the way to preclude interference. The coupon pages 6 are also sufficiently out of the way to allow normal use in a card transaction machine. The same is true for use in hotel key card slots, that sometimes include vertical insertion of the card 4.

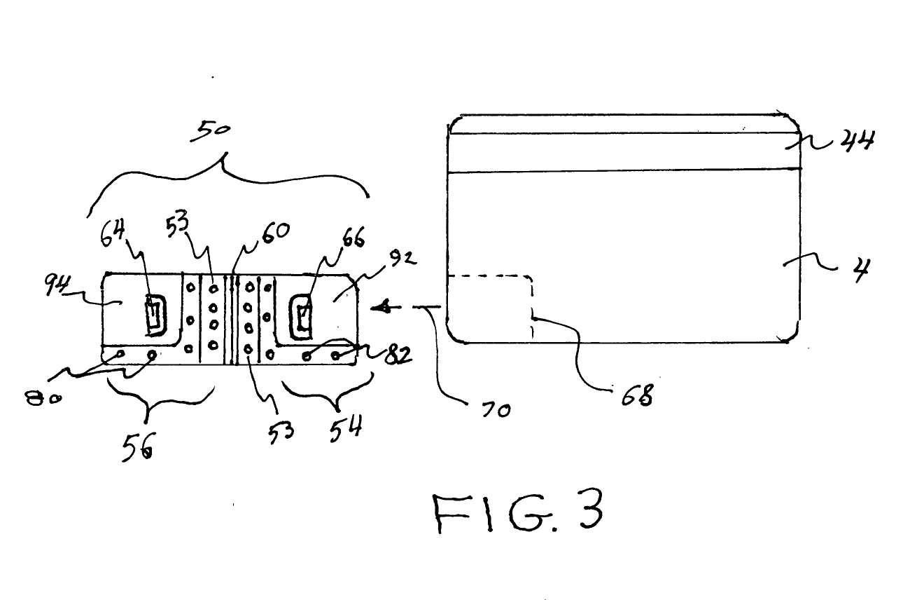

FIG. 3 shows the mating assembly 50 in the open position. The assembly is comprised of two equal halves 54, 56 that are connected by an integral living hinge 60. The mating member is molded of a rigid material such as polypropylene which can incorporate living hinge capability. One half 54 includes a plurality of posts 82 and the other half 56 includes a plurality of mating apertures 80 so that when the two halves 54, 56 are folded upon each other the posts 82 and the apertures 80 frictionally interact to force the two halves to remain locked together. Of course, other known means of locking the two halves together my be employed. Additionally, the two halves 56, 54 may be molded separately, and they may be screwed together or held in place by an adhesive. Each half 54, 56 includes an inwardly facing metal blade 64, 66 that each are fixedly retained by their respective plastic molded halves 54. 56 and rise up at an angle as will be shown in FIG. 4. Credit card sized cover 4 can be inserted into mating assembly 50 either before the assembly 50 is folded in half, or after assembly 50 is folded in half. Insertion is indicated by arrow 70. Area of card 4 to be retained by assembly 50 is indicated by dotted line 68. Flat portions 92, 94 are recessed just enough to enable the surrounding walls to completely close even when card 4 is inserted.

FIG. 4 shows a side section 200 of the invention 100. Blades 64, 66 can be clearly seen impinging on card 4. If a person tries to pull card 4 from the mating assembly 50, the blades 64, 66 would tend to dig deeper into card 4 making it very difficult to remove. Post 82 can be seen frictionally mated into aperture 80. Spiral binder 52 can be clearly seen to be retaining both the cover card 4 and the attached pages 6. Other standard binding techniques may also be used to hold pages 6 to the assembly 50. The pages 6 are made of durable paper or light plastic sheet material. They can be made to remain with the assembly 50 or can include perforations to allow easy pulled out from binder 52 when so desired.

Tab 58 can be seen retaining pages 6. Living hinge 60 can be seen inside binder ring 52.

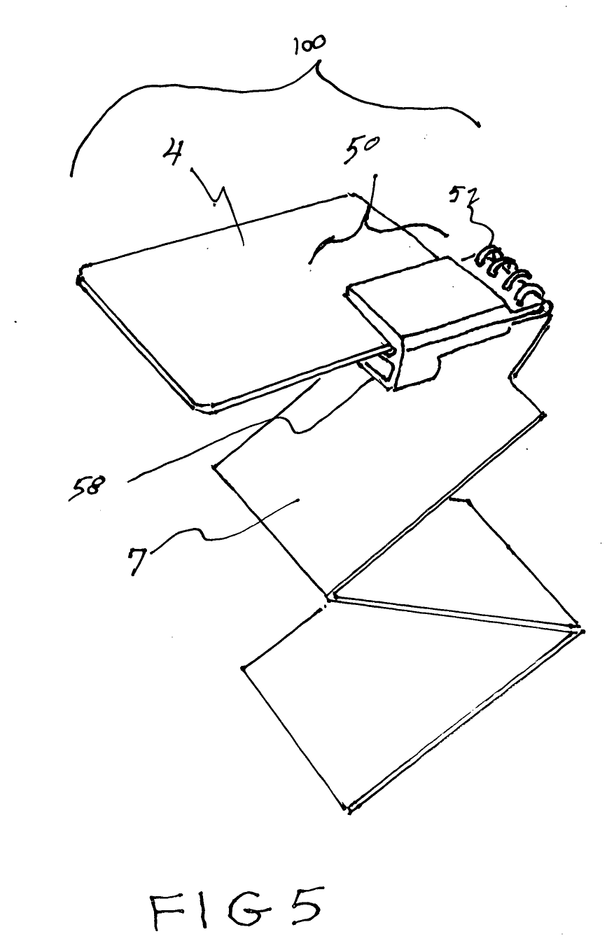

FIG. 5 shows a perspective view of the invention 100 with an alternate page format as shown by accordion fold pages 7. The folded pages 7 can be retained by tab 58 in the same way that pages 6 are retained as shown in previous figures.

As shown and described above, the present invention provides a way to mate a plurality of pages to a credit card sized card without having the pages interfere with the swiping action of a normal card transaction. The card can be inserted into the mating assembly in mass at a fulfillment house or can be installed individually by a store or hotel clerk at the time of purchase.

FIG. 6 shows a side section view of an alternate embodiment of the invention that allows the completed assembly 150 to be thin and therefore easy to carry in a purse or wallet. This version requires that the credit sized card have a hole 164 pre-punched in the corner of the card. A post 162 located centrally on one side of the assembly 150A penetrates an aligned aperture in side 150B and then the post head 152 is ultrasonically welded so that the two sides 150A and 150B are forced together thereby trapping card 156. Pages 156, living hinge 160 and spiral binder 158 all work as in the preferred embodiment. It should be noted that other binders may be employed such as heat welding of plastic coated pages or other standard binding techniques. This alternate embodiment does not include tab 58 as shown in the preferred embodiment so that the entire assembly 150 may remain as thin as possible.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A means of attaching printed pages to a credit card sized cover comprising:
a rectangular plastic sheet;
a page binder;
said plastic sheet being made of molded rigid material such as polypropylene;
said plastic sheet having a living hinge bisecting said sheet so that said sheet can be folded in two halves whose inside surfaces touch each other;
said plastic sheet including recessed portions to allow the thickness of a standard plastic credit card to be entrapped within said plastic sheet halves;
said page binder attached to the said living hinge side of said folded sheet so that a plurality of pages may be attached to said binder thereby allowing said pages to remain in close proximity to said card.

2. A means of attaching a book to a credit card sized cover as claimed in claim 1 wherein said attachment means also includes:
a pair of plastic card retaining blades;
each said folded sheet half including a retaining means for said retaining blades;
said folded sheet half being forced to stay in a folded position by means of a plurality downwardly facing posts located on the inner side of the first said folded sheet and a plurality of matching post retaining sockets on the second said folded sheet;
said retaining blades positioned at an angle so that said blade portion is facing away from said plastic credit card as said card is pushed into said folded plastic sheet so that said card is prevented from being pulled out of said folded plastic sheet by the digging in action of said retaining blades;
each said folded sheet having a plurality of evenly spaced apertures located adjacent to and parallel to said living hinge so that when said sheet halves are folded, said apertures of each said folded sheet are aligned and
said plurality of spaced apertures capable of receiving a standard spiral wire binding capable of retaining a plurality of printed pages so that said pages form a book and said credit card sized sheet forms a book cover.

3. A means of attaching a book to a credit card sized cover as claimed in claim 1 further comprising a retaining tab attached to said second folded sheet half that is capable of temporarily holding said book pages so that they stay in close proximity to the cover until the user decides to turn said pages or remove said pages from said book cover.

4. A means of attaching a book to a credit card sized cover as claimed in claim 1 wherein said book attachment means is located on one corner of said credit sized cover so that the magnetic strip of said card can be accessed by standard card readers, or hotel lock readers.

5. A means of attaching a book to a credit card sized cover as claimed in claim 1 wherein an alternate version of said book includes an accordion fold book where the first page of said accordion is held by said spiral binder.

6. A means of attaching a book to a credit card sized cover as claimed in claim 1 wherein an alternate embodiment of said attachment means includes that the said credit card sized cover includes one or more apertures that allow a post or posts in the attachment means to be inserted into said card apertures apertures as a means of securing said cover to said attachment means.

7. A means of attaching a book to a credit card sized cover as claimed in claim 1 wherein an alternate embodiment of said attachment means includes separate top and bottom sheets rather than one sheet bisected by a living hinge.
